(19) United States
(12) Patent Application Publication
(10) Pub. No.: US 2026/0329453 A1
(43) Pub. Date: Oct. 22, 2026

(54) REACTIVE SELECT GATE MAINTENANCE OPERATIONS IN A MEMORY SUB-SYSTEM

(71) Applicant: MICRON TECHNOLOGY, INC., Boise, ID (US)

(72) Inventors: Devin M. Batutis, San Jose, CA (US); Chun Sum Yeung, San Jose, CA (US)

(21) Appl. No.: 19/181,830

(22) Filed: Apr. 17, 2025

(51) Int. Cl. G06F 3/06

(52) U.S. Cl. CPC G06F 3/0619; G06F 3/0655; G06F 3/0679

(57) ABSTRACT

A system comprises a memory device and a processing device, the processing device operatively coupled with the memory device. The processing device performs a read operation on a memory block. The processing device detects a triggering condition for a select gate maintenance operation, wherein the triggering condition is associated with a read error handling (REH) process resulting from the read operation on the memory block. Responsive to detecting the triggering condition for the select gate maintenance operation, the processing device performs the select gate maintenance operation.

### TECHNICAL FIELD

Embodiments of the disclosure relate generally to memory sub-systems, and more specifically, relate to performing reactive select gate maintenance operations in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system in accordance with some embodiments of the present disclosure.

FIG. 2 is a block diagram illustrating select gate devices in a memory block of a memory device in a memory sub-system in accordance with some embodiments of the present disclosure.

FIG. 3 is a flow diagram of an example method of performing reactive select gate maintenance operations in a memory sub-system, in accordance with some embodiments of the present disclosure.

FIG. 4 is a chart depicting a result of performing a select gate maintenance operation on a memory block, in accordance with some embodiments of the present disclosure.

FIG. 5 is a block diagram of an example computer system in which embodiments of the present disclosure may operate.

### DETAILED DESCRIPTION

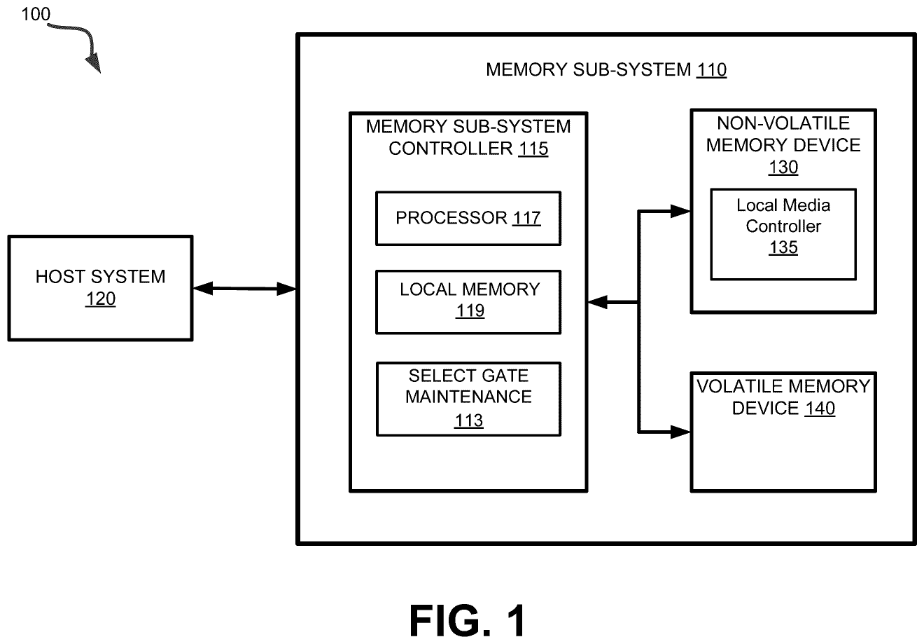

Aspects of the present disclosure are directed to reactive select gate maintenance operations in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed onto a silicon wafer in an array of columns and rows. A bitline can refer to one or more conductive lines coupled to a column of associated memory cells in a memory device. A wordline can refer to one or more conductive lines coupled to a row of associated memory cells in a memory device that are used with one or more bitlines to generate the address of each of the memory cells. The intersection of a bitline and a wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device. Each memory block can include a number of sub-blocks, wherein each sub-block is defined by an associated pillar (e.g., a vertical conductive trace) extending from a shared bitline.

Since the sub-blocks can be accessed independently for operations such as programming or reading, the memory block may include a structure that selectively enables the pillar associated with a specific sub-block while disabling the pillars associated with others. In one embodiment, this structure comprises one or more select gate devices positioned at one or both ends of each pillar. Depending on a control signal applied, these select gate devices can either enable or disable the conduction of signals through the pillars. In one embodiment, the select gate devices associated with each pillar in the memory block are controlled separately.

Select gate devices can be implemented by respective floating gate transistors having a relatively long channel that provides good signal isolation when in the appropriate state. Alternatively, select gate devices can be implemented using replacement gate transistors which have a relatively short channel. The replacement gate transistors are programmable devices and thus offer the benefit of more versatility, but are susceptible to some amount of signal leakage. In addition, the programmable threshold voltage of replacement gate transistors can shift over time. While initially set at a certain target value, numerous factors including a number of program/erase cycles performed on the device, temperature changes, etc. can cause the threshold voltage of the select gate device to increase or decrease over time. This shift away from the target value can lead to charge loss causing the select gate device to function improperly, and potentially causing reliability problems in the data stored on the wordlines of the corresponding sub-block.

Read errors resulting from issues (e.g., charge loss) with select gates occur infrequently. With the latency introduced by select gate maintenance operations, many systems opt to forgo these operations altogether. However, improperly maintained select gates can lead to catastrophic read disturb errors and other read operation issues.

Aspects of the present disclosure address the above and other deficiencies by having a memory sub-system that performs select gate maintenance operations reactively. Specifically, responsive to detecting a triggering condition associated with a read error handling process resulting from the read operation on a memory block, the system performs a select gate maintenance operation on the memory block. In some embodiments, a select gate maintenance operation can be triggered by the system in response to a read error handling (REH) flow for the memory block. An REH flow comprises one or more operations performed on the data items retrieved from the memory device to detect, correct, and mitigate read errors. The REH flow can be in response to the system detecting a read error during a read operation on a memory block. In an example embodiment, the select gate maintenance operation is triggered by the REH flow for the memory block reaching a target stage. In some embodiments, the select gate maintenance operation can be triggered from the initiation of the REH flow. In some embodiments, the triggering condition is a satisfaction of a threshold criterion associated with the REH flow for the memory block. For example, the threshold criterion can be a maximum number of an operation (e.g., read retry) performed in the REH flow. Furthermore, in some embodiments, a select gate maintenance operation can be triggered in response to a signal to perform an REH operation on the memory block, wherein the REH operation is a media management operation (e.g., folding)

Advantages of the present disclosure include, but are not limited to improved latency and improved reliability. For example, by performing the select gate maintenance operation reactively, rather than periodically on a fixed schedule, minimizes unnecessary maintenance overhead and optimizes system resources by performing select gate maintenance operations only when needed. For example, in performing the select gate maintenance operation reactively in response to reaching a target stage of an REH flow for a memory block, the system can perform a lower-latency select gate maintenance operation, potentially amending the cause of the read error before performing a higher latency operation (e.g., a redundant array of independent NAND (RAIN) operation). This approach reduces latency by avoiding redundant checks and enhances reliability through prompt error mitigation.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a select gate maintenance component 113 that can perform select gate maintenance operations reactively. In some embodiments, the memory sub-system controller 115 includes at least a portion of the select gate maintenance component 113. In some embodiments, the select gate maintenance component 113 is part of the host system 120, an application, or an operating system. In other embodiments, local media controller 135 includes at least a portion of select gate maintenance component 113 and is configured to perform the functionality described herein.

The select gate maintenance component 113 can perform select gate maintenance operations reactively. Specifically, responsive to detecting a triggering condition associated with a read operation on a memory block, the system performs a select gate maintenance operation with respect to a select gate device associated with the memory block. The triggering condition is associated with a read error handling process resulting from the read operation on the memory block. In some embodiments, a select gate maintenance operation can be triggered by the system in response to a read error handling (REH) flow for the memory block. An REH flow comprises one or more operations performed on the data items retrieved from the memory device to detect, correct, and mitigate read errors. The REH flow can be in response to the system detecting a read error during a read operation on a memory block. In an example embodiment, the select gate maintenance operation is triggered by the REH flow for the memory block reaching a target stage. In some embodiments, the select gate maintenance operation can be triggered from the initiation of the REH flow. In some embodiments, the triggering condition is a satisfaction of a threshold criterion associated with the REH flow for the memory block. For example, the threshold criterion can be a maximum number of an operation (e.g., read retry) performed in the REH flow. Furthermore, in some embodiments, a select gate maintenance operation can be triggered in response to a signal to perform an REH operation on the memory block, wherein the REH operation is a media management operation (e.g., folding). Further details with regards to the operations of the select gate maintenance component 113 are described below.

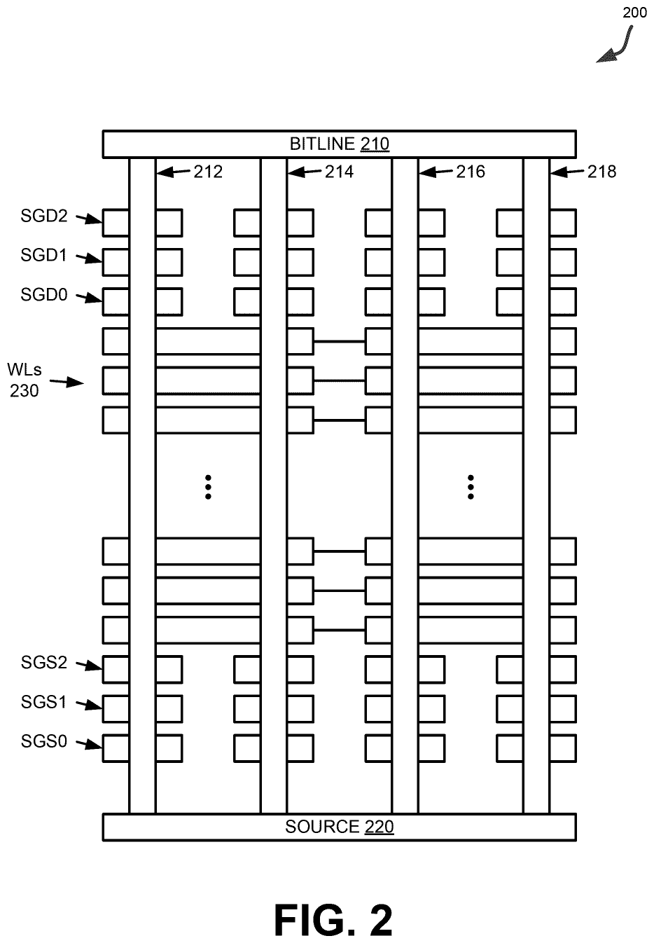

FIG. 2 is a block diagram illustrating select gate devices in a memory block of a memory device in a memory sub-system in accordance with some embodiments of the present disclosure. In one embodiment, memory block 200 is representative of any of the memory blocks that make up memory device 130 or memory device 140. Memory block 200 can be one of a number of physical blocks in the memory device can include a set of memory pages. The memory pages store one or more bits of binary data corresponding to data received from the host system. The memory cells of memory block 200 can be arranged along a number of separate wordlines 230. Memory block 200 can include a shared bitline 210 having a number of pillars 212, 214, 216, 218 extending therefrom to a separate source line 220. Each pillar can be a vertical conductive trace and the intersections of each of pillars 212, 214, 216, 218 and of each of wordlines 230 form the memory cells. Thus, each of pillars 212, 214, 216, 218 forms a separate sub-block within memory block 200, where each sub-block can be access separately. To enable an access operation, such as a program operation or a read operation, to be performed on a given sub-block, memory block 200 includes a number of select gate devices to selectively enable the pillar (e.g., pillar 212) associated with a certain sub-block, while disabling the pillars (e.g., pillars 214, 216, 218) associated with other sub-blocks. For example, each pillar can include a first number of select gate devices (e.g., select gate drain devices (SGD), SGD0, SGD1, SGD2) at a first end (e.g., a drain end) and a second number of select gate devices (e.g., select gate source devices (SGSs), SGS0, SGS1, SGS2) at a second end (e.g., a source end).

In one embodiment, the select gate devices in memory block 200 are formed using programmable replacement gate transistors. Thus, the select gate devices have a programmed threshold voltage. Depending on a magnitude of a control signal applied relative to the threshold voltage, the select gate devices can either enable or disable the conduction of signals through the corresponding pillar. For example, if the magnitude of the control signal applied to a select gate device is less than the threshold voltage, the select gate device can be turned off and can prevent signal flow through the corresponding pillar. Conversely, if the magnitude of the control signal is greater than the threshold voltage, the select gate device can be turned on and can permit signal flow through the corresponding pillar. In some embodiments, the select gate devices associated with each pillar in memory block 200 are controlled separately, such that signal flow can be prevented in certain pillars while permitted in other pillars at the same time. Replacement gate transistors have a relatively short internal channel length, and thus are susceptible to some amount of signal leakage. Accordingly, in one embodiment, each pillar in memory block 200 has multiple select gate devices and each of the drain end and the source end, effectively increasing the internal channel length to provide better signal isolation when turned off.

The programmable threshold voltage of the select gate devices can shift over time. While initially set at a certain target value, numerous factors such as, a number of program/erase cycles performed on the device, changes in temperature, etc. can cause the threshold voltage of a select gate device to increase or decrease over time. This shift away from the target value can lead to charge loss causing the select gate device to function improperly, and potentially causing reliability problems in the data stored on the wordlines 230 of the corresponding sub-block. Accordingly, in one embodiment, select gate maintenance component 113 can reactively perform maintenance operations on select gate devices SGD0, SGD1, SGD2 or SGS0, SGS1, SGS2 of memory block 200. In one embodiment, the maintenance operations include a process where select gate maintenance component 113 iteratively applies a series of program voltage pulses to a select gate device. This brings the current threshold voltage of the select gate device back to a target threshold voltage. In some embodiments, the targe threshold voltage is predetermined. After each iteration, the processing logic verifies whether the current threshold voltage has reached the target threshold voltage. Upon being returned to the target threshold voltage, the select gate device can function properly, such that it will turn on or off correctly in response to receiving a corresponding control signal.

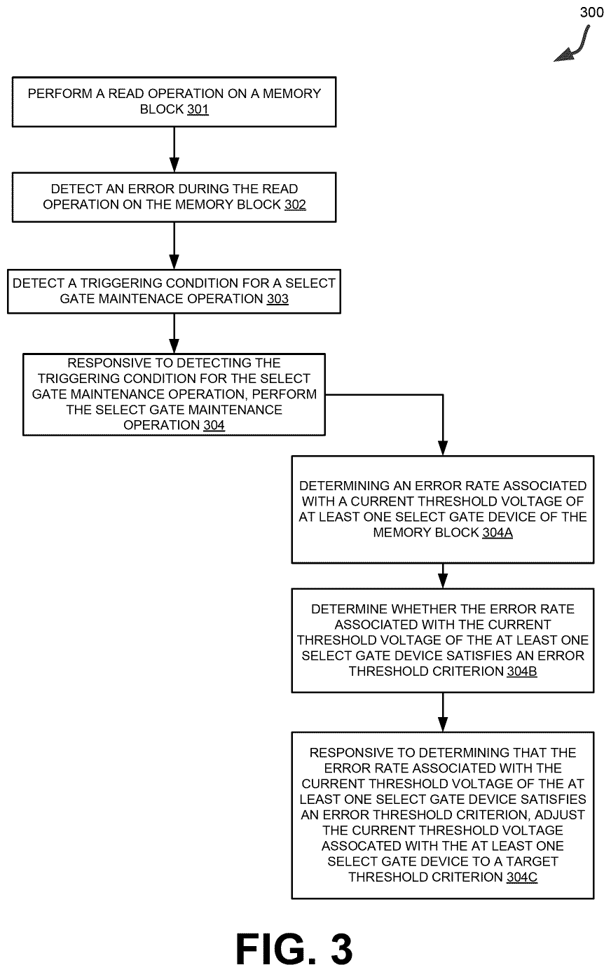

FIG. 3 is a flow diagram of an example method 300 of performing reactive select gate maintenance operations in a memory sub-system, in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the select gate maintenance component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 301, the processing logic (e.g., select gate maintenance component 113) performs a read operation on a memory block.

At operation 302, in some embodiments, the processing logic detects a read error during the read operation on the memory block. In some embodiments, the processing logic actively monitors the integrity of the data being retrieved. It can use error detection techniques such as parity checks or error correction codes (ECC). In embodiments, when a memory block is read, the system calculates a checksum and/or examines embedded parity/ECC bits. If these calculated values do not match the expected results stored with the data, the processing logic can recognize this discrepancy as a read error. Consequently, in some embodiments, the system can trigger error-handling procedures (e.g., an REH flow)—such as retrying the read operation, logging the error, or invoking corrective actions—to maintain data integrity.

At operation 303, the processing logic detects a triggering condition for a select gate maintenance operation, wherein the triggering condition is associated with the read operation on the memory block. In some embodiments, the processing logic continuously monitors for pre-configured triggers associated with the read operation and/or read error handling. In some embodiments, when one of these triggers is detected, the processing logic flags the condition.

At operation 304, responsive to detecting the triggering condition for the select gate maintenance operation, the processing logic performs the select gate maintenance operation with respect to a select gate device associated with the memory block.

In some embodiments, at operation 303, the triggering condition is the initiation of an REH flow for the memory block. In some embodiments, the initiation of the REH flow is in response to detecting a read error during a read operation of the memory block. In some embodiments, at operation 303, the triggering condition is a read error handling (REH) flow for the memory block reaching a target stage. An REH flow can include one or more REH operations with respect to the data items that have been retrieved from the memory device. An error handling operation can include one or more read retries using different parameters, such as a change in read voltage, as compared to the initial read operation performed on the memory cell. The error-handling operation can also include “deep error handling techniques,” such as forward error correction (FEC) with various versions of reliability information, hybrid automatic repeat request (HARQ), etc. For example, upon entering the REH flow, the memory sub-system controller can first perform a set of relatively low latency steps, such as a predetermined amount read retries using varying, relatively small (e.g., not exceeding a predefined threshold) read offsets applied to the base read level. Responsive to the low latency steps successfully recovering the data, the memory sub-system controller can exit the error-handing flow to resume read and write operations. Responsive to the low latency steps failing to recover the data, the memory sub-system controller can perform the next REH operations specified in the REH flow. For example, the memory sub-system controller can perform higher latency steps, such as applying larger read offsets as compared to the read offsets used in the low latency steps, or using deep error-handling techniques (e.g., FEC, HARQ, etc.) to recover the data.

In one embodiment, the triggering condition is a REH flow reaching the target stage of a redundant array of independent NAND (RAIN) operation. In this context, the storage controller implements a RAIN operation to provide redundancy for the data stored across various streams. This redundancy protects the data in case a portion of the memory device storing data for a specific stream fails. For instance, when data from a particular stream is written to the storage system, parity data may be generated using an exclusive-or (XOR) operation on the received data. This parity data is then stored alongside the user memory blocks in different areas of the memory devices. If a failure occurs in the memory portion containing one of these user memory blocks, the lost data can be reconstructed by performing an XOR operation on the remaining user memory blocks and the stored parity data.

Since RAIN operations are high-latency processes, the triggering condition is designed to enable the system to perform a lower-latency select gate maintenance operation beforehand, potentially avoiding the higher latency RAIN operation on the memory block.

In some embodiments, at operation 303, the triggering condition is a satisfaction of a threshold criterion associated with an REH flow for the memory block. In some embodiments, the threshold criterion is a maximum number of operations performed on the memory block. For example, in an embodiment where the threshold criterion is a predetermined maximum number of read retry operations performed on the block, responsive to determining that the processing logic has performed a predetermined maximum number of read retry operations on a memory block, at operation 304, the processing logic performs the select gate maintenance operation. In some embodiment, the number of operations performed is stored in a metadata table and incremented using a counter.

In some embodiments, at operation 303, the triggering condition is a signal for performing an REH operation on the memory block. In some embodiments, the REH operation is a media management operations. Possible media management operations include “folding.” Also known as “refreshing,” folding is a media management operation performed by the processing logic involving rearranging and consolidating memory segments (for example, implementations using NAND technology can use blocks associated with the third set of target cells) to clear space occupied by “garbage” (invalid) data that is no longer in use. Folding merges smaller memory chunks comprising valid data into larger available memory blocks to minimize fragmentation and wasted space in the memory device.

In some embodiments, in performing the select gate maintenance operation, at operation 304A the processing logic determines an error rate associated with a current threshold voltage of at least one select gate device of the memory block. In some embodiments, the processing logic determines the error rate as part of a scan. The select gate maintenance component 113 identifies one or more reliability statistics, such as the raw bit error rate (RBER) representing a number of bit errors per total number of bits that the select gate experiences. In one embodiment, during the scan, select gate maintenance component 113 applies one or more read voltages to the select gate device SGD0 and receives one or more output values based on the one or more read voltages. For example, select gate maintenance component 113 reads a raw code word (i.e., a series of a fixed number of bits) from the select gate device SGD0, applies the code word to an error correcting code (ECC) decoder to generate a decoded code word, and compare the decoded code word to the raw code word (i.e., the expected output value). Select gate maintenance component 113 can count a number of flipped bits between the decoded code word and the raw code word, with a ratio of the number of flipped bits to the total number of bits in the code word representing the RBER. Select gate maintenance component 113 can repeat this process for additional code words until each of the select gate devices in the memory block 200 have been scanned.

At operation 304B, the processing logic determines whether the error rate associated with the current threshold voltage of the at least one select gate device (e.g., SGD0) satisfies an error threshold criterion. In one embodiment, select gate maintenance component 113 compares the error rate to an error threshold which represents an error correction capability of the memory device. If the error rate does not meet or exceed the error threshold, the processing logic determines that the error threshold criterion is not satisfied and does not continue with the select gate maintenance operation. For example, in an embodiment where the triggering condition is reaching a target state of an REH flow, responsive to determining the error threshold criterion is not satisfied, the processing logic continues to the next stage (e.g., operation) of the REH flow. If, however, the error rate does meet or exceed the error threshold, the processing logic determines that the error threshold criterion is satisfied.

In one embodiment, select gate maintenance component 113 examines the first error rate to determine whether the current threshold voltage has decreased below the target threshold voltage or increased above the target threshold voltage. In one embodiment, if the current threshold voltage has decreased below the target threshold voltage, select gate maintenance component 113 can perform an operation to increase the current target threshold voltage to the target threshold voltage. In one embodiment, select gate maintenance component 113 performs a single scan to determine if the current threshold voltage has decreased below the target threshold voltage (e.g., to identify a “lower tail”) or has increased above the target threshold voltage (e.g., to identify an “upper tail”). In another embodiment, separate scans can be performed. For example, select gate maintenance component 113 can perform a second scan to determine whether the current threshold voltage has increased above the target threshold voltage. If the current threshold voltage has increased above the target threshold voltage, select gate maintenance component 113 can retire the memory block 200.

Responsive to determining that the error rate associated with the current threshold voltage of the at least one select gate device satisfies an error threshold criterion, at operation 304C, the processing logic adjusts the current threshold voltage associated with the at least one select gate device to a target threshold voltage. For example, if the first error rate associated with the current threshold voltage of the at least one select gate device SGD0 satisfies the error threshold criterion, the processing logic performs an operation on the at least one select gate device SGD0 to adjust the current threshold voltage to the target threshold voltage. In one embodiment, select gate maintenance component 113 iteratively applies a plurality of program pulses to at least one select gate device SGD0, to a subset of the select gate devices of memory block 200, or to all of the select gate devices of memory block 200, to adjust the current threshold voltage of the select gate device(s) back to the target threshold voltage. Select gate maintenance component 113 can verify, after each iteration, whether the current threshold voltage has reached the target threshold voltage, to ensure that the threshold voltage slowly steps back up to the target threshold voltage, without exceeding the target threshold voltage.

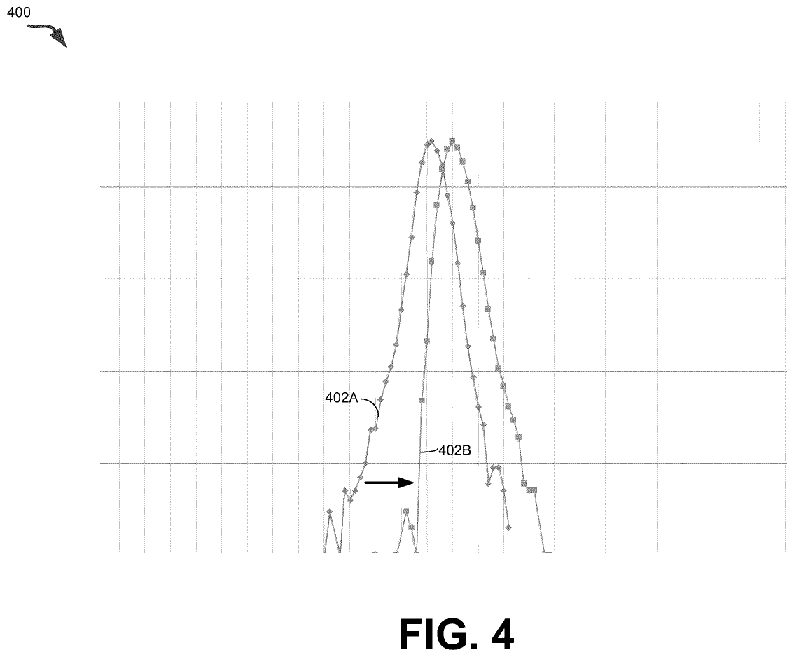

FIG. 4 is a chart 400 depicting a result of performing a select gate maintenance operation on a memory block, in accordance with some embodiments of the present disclosure. Specifically, the chart 400 depicts an embodiment where the processing logic determines that the error rate associated with the current threshold voltage of the at least one select gate device satisfies an error threshold criterion and thus adjusts the current threshold voltage 402A associated with the at least one select gate device (e.g., SGD0) to a target threshold voltage 402B.

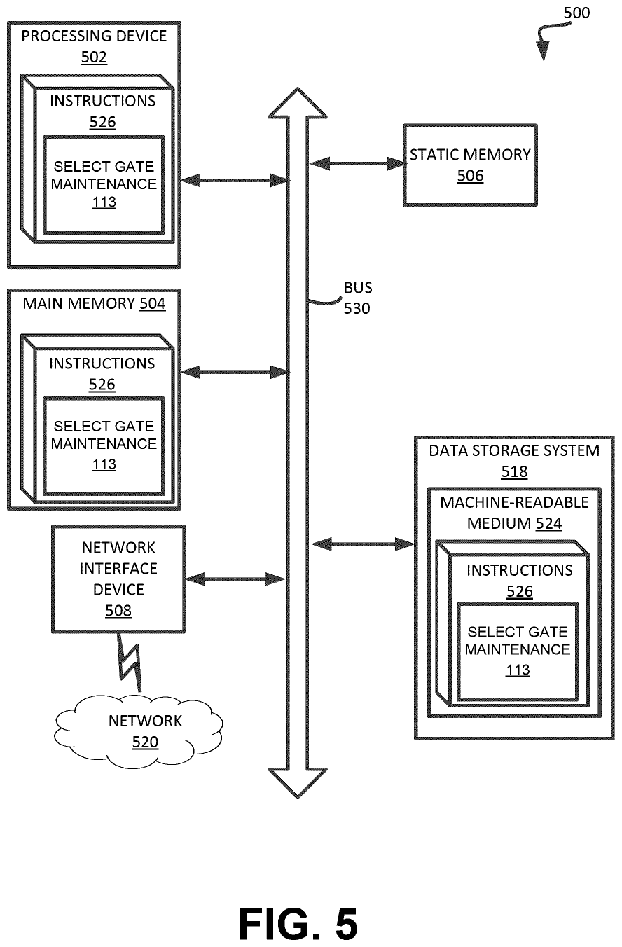

FIG. 5 illustrates an example machine of a computer system 500 within which a set of instructions, for causing the machine to perform any one or more of the methodologies discussed herein, can be executed. In some embodiments, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the select gate maintenance component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., read-only memory (ROM), flash memory, dynamic random access memory (DRAM) such as synchronous DRAM (SDRAM) or RDRAM, etc.), a static memory 506 (e.g., flash memory, static random access memory (SRAM), etc.), and a data storage system 518, which communicate with each other via a bus 530.

Processing device 502 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 502 can also be one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein. The computer system 500 can further include a network interface device 508 to communicate over the network 520.

The data storage system 518 can include a machine-readable storage medium 524 (also known as a computer-readable medium) on which is stored one or more sets of instructions 526 or software embodying any one or more of the methodologies or functions described herein. The instructions 526 can also reside, completely or at least partially, within the main memory 504 and/or within the processing device 502 during execution thereof by the computer system 500, the main memory 504 and the processing device 502 also constituting machine-readable storage media. The machine-readable storage medium 524, data storage system 518, and/or main memory 504 can correspond to the memory sub-system 110 of FIG. 1.

In one embodiment, the instructions 526 include instructions to implement functionality corresponding to a select gate maintenance component (e.g., the select gate maintenance component 113 of FIG. 1). While the machine-readable storage medium 524 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled with the memory device, to perform operations comprising:
performing a read operation on a memory block;
detecting a triggering condition for a select gate maintenance operation, wherein the triggering condition is associated with a read error handling (REH) process resulting from the read operation on the memory block; and
responsive to detecting the triggering condition for the select gate maintenance operation, performing the select gate maintenance operation with respect to a select gate device associated with the memory block.

2. The system of claim 1, wherein performing the select gate maintenance operation comprises:
determining an error rate associated with a current threshold voltage of at least one select gate device of the memory block;
determining whether the error rate associated with the current threshold voltage of the at least one select gate device satisfies an error threshold criterion; and
responsive to determining that the error rate associated with the current threshold voltage of the at least one select gate device satisfies an error threshold criterion, adjusting the current threshold voltage associated with the at least one select gate device to a target threshold voltage.

3. The system of claim 1, wherein the triggering condition is an REH flow for the memory block reaching a target stage.

4. The system of claim 1, wherein the triggering condition is a signal for performing an REH operation on the memory block, and wherein the REH operation is a media management operation.

5. The system of claim 1, wherein the triggering condition is a satisfaction of a threshold criterion associated with an REH flow for the memory block.

6. The system of claim 5, wherein the threshold criterion is a maximum number of read retry operations performed on the memory block.

7. The system of claim 1, wherein the triggering condition is an initiation of an REH flow for the memory block.

8. The system of claim 1, wherein the operations further comprise:
detecting a read error resulting from the read operation on the memory block.

9. A method comprising:
performing, by a processing device, a read operation on a memory block of a memory device;
detecting a triggering condition for a select gate maintenance operation, wherein the triggering condition is associated with a read error handling (REH) process resulting from the read operation on the memory block; and
responsive to detecting the triggering condition for the select gate maintenance operation, performing the select gate maintenance operation with respect to a select gate device associated with the memory block.

10. The method of claim 9, wherein performing the select gate maintenance operation comprises:
determining an error rate associated with a current threshold voltage of at least one select gate device of the memory block;
determining whether the error rate associated with the current threshold voltage of the at least one select gate device satisfies an error threshold criterion; and
responsive to determining that the error rate associated with the current threshold voltage of the at least one select gate device satisfies an error threshold criterion, adjusting the current threshold voltage associated with the at least one select gate device to a target threshold voltage.

11. The method of claim 9, wherein the triggering condition is an REH flow for the memory block reaching a target stage.

12. The method of claim 9, wherein the triggering condition is a signal for performing an REH operation on the memory block, and wherein the REH operation is a media management operation.

13. The method of claim 9, wherein the triggering condition is a satisfaction of a threshold criterion associated with an REH flow for the memory block.

14. The method of claim 9, wherein the triggering condition is an initiation of an REH flow for the memory block.

15. A non-transitory computer-readable storage medium comprising instructions that, when executed by a processing device, cause the processing device to perform operations comprising:
performing a read operation on a memory block of a memory device;
detecting a triggering condition for a select gate maintenance operation, wherein the triggering condition is associated with a read error handling (REH) process resulting from the read operation on the memory block; and
responsive to detecting the triggering condition for the select gate maintenance operation, performing the select gate maintenance operation with respect to a select gate device associated with the memory block.

16. The non-transitory computer-readable storage medium of claim 15, wherein performing the select gate maintenance operation comprises:
determining an error rate associated with a current threshold voltage of at least one select gate device of the memory block;
determining whether the error rate associated with the current threshold voltage of the at least one select gate device satisfies an error threshold criterion; and
responsive to determining that the error rate associated with the current threshold voltage of the at least one select gate device satisfies an error threshold criterion, adjusting the current threshold voltage associated with the at least one select gate device to a target threshold voltage.

17. The non-transitory computer-readable storage medium of claim 15, wherein the triggering condition is an REH flow for the memory block reaching a target stage.

18. The non-transitory computer-readable storage medium of claim 15, wherein the triggering condition is a signal for performing an REH operation on the memory block, and wherein the REH operation is a media management operation.

19. The non-transitory computer-readable storage medium of claim 15, wherein the triggering condition is a satisfaction of a threshold criterion associated with an REH flow for the memory block.

20. The non-transitory computer-readable storage medium of claim 15, wherein the operations further comprise:
detecting a read error resulting from the read operation on the memory block.
